(19) United States
(12) Patent Application Publication
(10) Pub. No.: US 2023/0000157 A1
(43) Pub. Date: Jan. 5, 2023

(54) AEROSOL PROVISION SYSTEM WITH A MOVEMENT MECHANISM

(71) Applicant: Nicoventures Trading Limited, London (GB)

(72) Inventors: Walid ABI AOUN, London (GB); Patrick MOLONEY, London (GB); Justin Han Yang CHAN, London (GB)

(21) Appl. No.: 17/756,488

(22) PCT Filed: Nov. 27, 2020
(86) PCT No.: PCT/EP2020/083791

§ 371 Date: May 26, 2022

(30) Foreign Application Priority Data
Nov. 29, 2019 (GB) 1917449.9

(51) Int. Cl. A24F 40/46; A24F 40/20; A24F 40/42; A24F 40/465

(52) U.S. Cl. CPC A24F 40/46; A24F 40/20; A24F 40/42; A24F 40/465; H05B 6/105

(57) ABSTRACT

An aerosol provision system is disclosed comprising an aerosol generating component for generating an aerosol from an aerosol generating material. The system further comprises a consumable comprising aerosol generating material, the consumable defining a surface at which at least part of the aerosol generating material is disposed the surface having a characteristic extent in a first direction and a characteristic extent in a second direction and a movement mechanism for providing relative movement between the aerosol generating component and the consumable. The movement mechanism is arranged to provide relative movement between the aerosol generating component and the consumable along an axis substantially parallel to the first direction and along an axis substantially parallel to the second direction.

### PRIORITY CLAIM

The present application is a National Phase entry of PCT Application No. PCT/EP2020/083791, filed Nov. 27, 2020, which claims priority from Great Britain Application No. 1917449.9, filed Nov. 29, 2019, each of which is hereby fully incorporated herein by reference.

### TECHNICAL FIELD

The present disclosure relates to an aerosol provision system, a method of producing an aerosol from a consumable, an aerosol provision device and aerosol provision means.

### BACKGROUND

Aerosol provision systems are known.

Aerosol generating components are used in aerosol provision system to provide aerosols from aerosol generating material. The aerosol generating component may be oscillators or heaters or the like. When aerosol generating material is inserted into the aerosol provision system, effective aerosolization can be provided by a suitably arranged aerosol generating component. Modern devices often tailor the aerosol generating component and the aerosol generating material to provide a desirable aerosol for inhalation. Flexibility in this tailoring need is desirable.

The present disclosure is directed toward solving some of the above problems.

### SUMMARY

In accordance with some embodiments described herein, there is provided an aerosol provision system comprising: an aerosol generating component for generating an aerosol from an aerosol generating material; a consumable comprising aerosol generating material, the consumable defining a surface at which at least part of the aerosol generating material is disposed the surface having a characteristic extent in a first direction and a characteristic extent in a second direction; and a movement mechanism for providing relative movement between the aerosol generating component and the consumable, wherein the movement mechanism is arranged to provide relative movement between the aerosol generating component and the consumable along an axis substantially parallel to the first direction and along an axis substantially parallel to the second direction.

The movement mechanism may be configured to provide relative movement between the aerosol generating component and the consumable such that different regions of the consumable are individually aligned with the aerosol generating component.

The consumable may comprise a carrier support on which the aerosol generating material is arranged, the carrier support defining the surface having a characteristic extent in the first direction and the second direction.

The surface may define a plane extending along the first direction and the second direction.

The first direction is substantially orthogonal to the second direction.

The movement mechanism may be arranged to provide movement to the aerosol generating component.

The aerosol generating component may have a surface which extends in the first and second directions, wherein the area defined by the surface is less than the area define by the surface of the consumable.

The aerosol provision system may comprises a receptacle for receiving at least a part of the consumable, and wherein the aerosol generating component may be provided within the receptacle and may be configured to move relative to the receptacle in the first direction and the second direction.

The movement mechanism may be further arranged to further provide relative movement between the aerosol generating component and the consumable along an axis substantially perpendicular to the first direction and the second direction.

The movement mechanism may also be arranged to move the aerosol generating component relative to the consumable to provide contact between the aerosol generating component and the consumable.

The aerosol generating component may be a heating element.

The consumable may comprise a plurality of aerosol generating materials disposed in the first direction and the second direction.

The aerosol provision system may further comprise a second aerosol generating component configured to move in the first direction and/or second direction, wherein the second aerosol generating component is controlled to move to a different position in the first and second direction compared to the first aerosol generating component.

At least a part of the aerosol generating material may be an amorphous solid.

In accordance with some embodiments described herein, there is provided an aerosol provision device for providing an aerosol, the device comprising: an aerosol generating component for generating an aerosol from an aerosol generating material; a receptacle for receiving a consumable; and a movement mechanism for providing relative movement between the aerosol generating component and the receptacle, wherein the movement mechanism is arranged to provide relative movement between the aerosol generating component and the receptacle along an axis substantially parallel to a first direction and along an axis substantially parallel to a second direction.

In accordance with some embodiments described herein, there is provided a method of generating aerosol from a consumable, the method comprising: providing an aerosol generating component; providing a consumable comprising aerosol generating material, the consumable defining a surface at which at least part of the aerosol generating material is disposed, the surface having a characteristic extent in a first direction and a characteristic extent in a second direction; and providing a movement mechanism for providing relative movement between the aerosol generating component and the consumable, moving the aerosol generating component relative to the consumable along at least one of: an axis substantially parallel to the first direction; and, an axis substantially parallel to the second direction and activating the aerosol generating component to generate an aerosol from the aerosol generating material.

The method may also provide relative movement between the aerosol generating component and the consumable such that different regions of the consumable are individually aligned with the aerosol generating component.

The method may further provide relative movement between the aerosol generating component and the consumable along an axis substantially perpendicular to the first direction and the second direction.

The method may comprise moving the aerosol generating component relative to the consumable along an axis substantially perpendicular to the first direction and the second direction to provide contact between the aerosol generating component and the consumable.

The method may also comprise moving the aerosol generating component relative to the consumable to a first location and heating a first portion of aerosol generating material, moving the aerosol generating component relative to the consumable to a second location and heating a second portion of aerosol generating material, wherein the first portion of aerosol generating material and the second portion of aerosol generating material are different aerosol generating materials.

The aerosol generating component may be a heating element arranged to heat the aerosol generating material to generate an aerosol.

The consumable may comprise a carrier support, the aerosol generating material being arranged on the carrier support and wherein the carrier support defines the surface having a characteristic extent in the first direction and the second direction.

The method may further comprise arranging at least a part of the consumable in a receptacle, arranging the aerosol generating component in the receptacle, moving the aerosol generating component relative to the receptacle in the first and second direction.

In accordance with some embodiments described herein, there is provided aerosol provision means comprising: an aerosol generating component for generating an aerosol from an aerosol generating means; and, a consumable comprising aerosol generating material, the consumable defining a surface at which at least part of the aerosol generating material is disposed the surface having a characteristic extent in a first direction and a characteristic extent in a second direction; and a movement means for providing relative movement between the aerosol generating component and the consumable, wherein the movement means is arranged to provide relative movement between the aerosol generating component and the consumable along an axis substantially parallel to the first direction and along an axis substantially parallel to the second direction.

### BRIEF DESCRIPTION OF THE DRAWINGS

The present teachings will now be described by way of example only with reference to the following figure:

FIG. 1 is a longitudinal cross-sectional view of an aerosol provision system according to an example;

FIG. 2 is a perspective view of a portion of an aerosol provision system according to an example;

FIG. 3 is a perspective view of a portion of an aerosol provision system according to an example;

FIG. 4 is a longitudinal cross-sectional view of an aerosol provision system according to an example;

FIG. 5 is a perspective view of a portion of an aerosol provision system according to an example;

FIG. 6 is a longitudinal cross-sectional view of an aerosol provision system according to an example; and,

FIG. 7 is a schematic flowchart for a method of producing an aerosol according to an example.

While the disclosure is susceptible to various modifications and alternative forms, specific embodiments are shown by way of example in the drawings and are herein described in detail. It should be understood, however, that the drawings and detailed description of the specific embodiments are not intended to limit the disclosure to the particular forms disclosed. On the contrary, the disclosure covers all modifications, equivalents and alternatives falling within the scope of the present disclosure.

### DETAILED DESCRIPTION OF THE DRAWINGS

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. According to the present disclosure, a “non-combustible” aerosol provision system is one where a constituent aerosolizable material of the aerosol provision system (or component thereof) is not combusted or burned in order to facilitate delivery to a user. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapor”, and related terms such as “vaporize”, “volatilize” and “aerosolize”, may generally be used interchangeably.

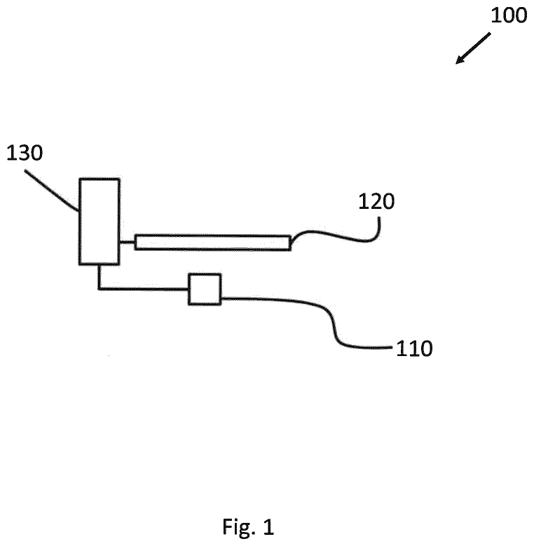

In the example of FIG. 1, an aerosol provision system 100 is shown. The aerosol provision system 100 comprises an aerosol generating component 110. The aerosol generating component 110 is for generating an aerosol from an aerosol generating material. The aerosol provision system 100 also comprises a consumable 120 comprising aerosol generating material. The consumable 120 defines a surface at which at least part of the aerosol generating material is disposed, the surface having a characteristic extent in a first direction and a characteristic extent in a second direction. The aerosol provision system 100 also comprises a movement mechanism 130. The movement mechanism 130 is for providing relative movement between the aerosol generating component 110 and the consumable 120. The movement mechanism 130 is arranged to provide relative movement between the aerosol generating component 110 and the consumable 120 along an axis substantially parallel to the first direction and along an axis substantially parallel to the second direction.

The aerosol generating component 110 may be a heating element. The aerosol generating component 110 may be a heating mechanism or part of a heating mechanism. In an example, the aerosol generating component 110 may be a heater for providing heat to the aerosol generating material in the consumable 120. The aerosol generating component 110 may be a resistive heater to provide heat to the consumable 120 from a current passed through it by an electrically connected power source. The aerosol generating component 110 may be made of metal or ceramic or the like. Alternatively or additionally, the aerosol generating component 110 may be an induction heater or a part of an inductive heating system for providing heat to the consumable 120.

The consumable 120 may be a block of aerosol generating material such as tobacco or the like. The consumable 120 may be a sheet of aerosol generating material such as tobacco or the like.

The surface defined by the consumable may be a curved surface or a flat surface. For example, the consumable may be a sheet or may be in the form of a sphere or the like. Therefore, the characteristic extent in the first direction and the second direction may relate to the projection of the surface onto a plane defined by the first direction and the second direction. In this sense, the surface may be a virtual surface.

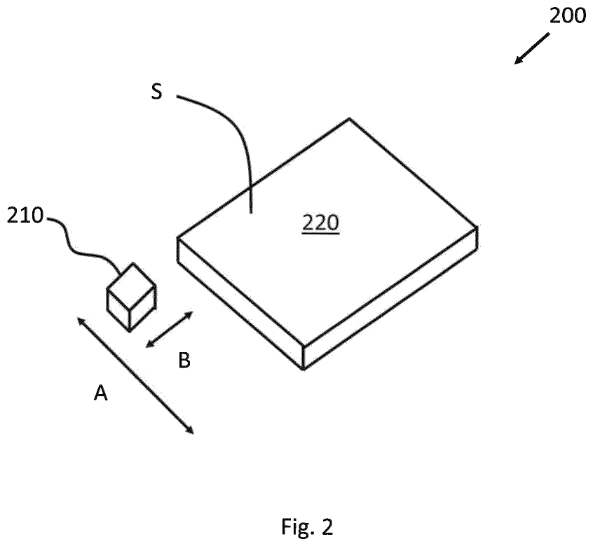

In the example of FIG. 2, a portion of an aerosol provision system 200 is shown in a perspective view. An aerosol generating component 210 and a consumable 120 are shown. In the example shown, the consumable 220 is relatively long in two directions (e.g. an “x-direction” and a “y-direction”) and is relatively short in one direction (e.g. a “z-direction”). The aerosol generating component 210 shown is of similar lengths in these directions.

The movement mechanism (not shown) may be configured to provide relative movement between the aerosol generating component 210 and the consumable 220. In the example of FIG. 2, this may be in the two directions indicated by the arrow A and arrow B. These coincide with the two directions in which the consumable 220 is relatively long. As such, the relative movement allows, e.g., the aerosol generating component 210 to pass over the full extent of the large surface A of the consumable 220. By pass over, this may mean that a lower side surface of the consumable 220 is passed by an upper side surface of the aerosol generating component 210. Alternatively, a lower side surface of the aerosol generating component 210 may be passed by an upper side surface of the consumable 220.

The movement mechanism in this example and the example of FIG. 1, may also be arranged to provide relative movement between the aerosol generating component 210 and the consumable 220 in one or more directions e.g. in the x, y, or z directions.

In another example, the movement mechanism may be configured to provide relative movement between the aerosol generating component 210 and the consumable 220 in an orthogonal direction relative to directions A and B i.e. the movement can be in the x, y or z direction. The relative movement can be provided in one or more directions simultaneously.

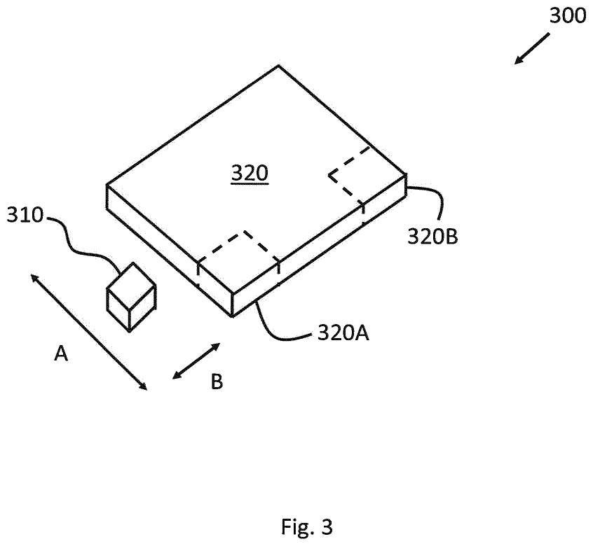

In the example of FIG. 3, a portion of an aerosol provision system 300 is shown in a perspective view. The example of an aerosol provision system 200 shown in FIG. 2 is similar to the example of an aerosol provision system 300 shown in FIG. 3. The aerosol provision system 300 shown in FIG. 3 has a slightly differently configured consumable 320.

The consumable 320 shown in FIG. 3 has two consumable regions 320A, 320B shown in dotted lines. The movement mechanism (not shown) may be configured to provide relative movement between the aerosol generating component 310 and the consumable 320 such that different regions of the consumable 320 are individually aligned with the aerosol generating component 310. These regions 320A, 320B may for example be aligned with the aerosol generating component 310 as a result of the movement mechanism relatively moving the aerosol generating component 310 a short distance in the direction indicated by arrow A, and then a short distance in the direction indicated by arrow B (to align with region 320A) or a long distance in the direction indicated by arrow B (to align with region 320B). In this way, the relative movement may allow for individual alignment of regions of the consumable 320 with the aerosol generating component 310.

In an example, the consumable 120, 220, 320 may comprise a carrier support on which the aerosol generating material is arranged. The carrier support may define the surface having a characteristic extent in the first direction and the second direction (e.g. in the directions indicated by arrow A and arrow B. The carrier support may be flat or may be curved in some manner.

The carrier support may be formed of a material which is thermally conductive to more easily allow heat to pass from the aerosol generating component 110, 210, 310 to the aerosol generating material on the carrier support. In an example, the carrier support may be formed of an inductive material, such as aluminum. This may allow for heating of the aerosol generating material to occur via induction.

The aerosol generating component 110, 210, 310 may be a work coil which may work with an aluminum susceptor to provide thermal energy to the aerosol generating material in the consumable 120, 220, 320.

In the example shown in FIG. 3, the surface of the consumable defines a plane extending along the first direction (indicated by arrow A) and the second direction (indicated by arrow B). In the specific example shown, the plane is a flat plane. In the example shown in FIG. 3, the first direction is substantially orthogonal to the second direction. In an example, the first direction (shown by arrow A) defines an “x” coordinate, and the second direction (shown by arrow B) defines a “y” coordinate, these together forming a plane. In an example, the first direction is orthogonal to the second direction.

In the example shown in FIG. 3, the movement provided by the movement mechanism (not shown) may be provided to the aerosol generating component 310. Moving the aerosol generating component 310 in the aerosol provision system efficiently uses the space within the aerosol provision system. The consumable 320 may be provided to fill part of the aerosol provision system. The aerosol generating component 310 may then be moved within that part of the aerosol provision system to then generate an aerosol from different regions 320A, 320B of the consumable 320. This results from the aerosol generating component 310 typically having a smaller area than the area of the consumable 320.

Alternatively, the movement provided by the movement mechanism (not shown) may be provided to the consumable 320. The aerosol generating component 310 will have associated electronics to deliver electrical signals for operation. Moving the aerosol generating component 310 may involve also moving such electronics. Therefore, moving the consumable 320 (which may have no associated electronics) is an organizationally simpler task. Furthermore, the consumable 320 could be arranged on a moving surface to provide movement to the consumable 320. This may also operate to increase the ease of insertion of the consumable 320 into the aerosol provision system, e.g. if the moving surface assists moving the consumable 320 from an edge of the aerosol provision system to a central heating portion of the aerosol provision system. The moving surface may be a conveyor belt system or the like for providing entry to the aerosol provision system from an opening on the outer of the aerosol provision system to a heating portion inside the aerosol provision system.

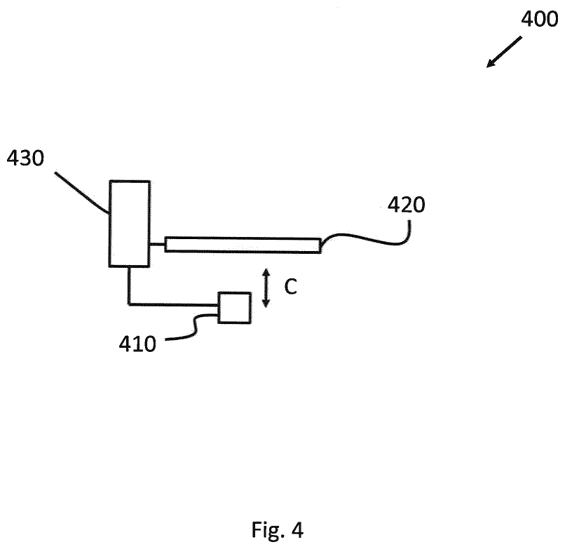

In the example of FIG. 4, a portion of an aerosol provision system 400 is shown. The aerosol provision system has an aerosol generating component 410, a consumable 420 and a movement mechanism 430. The movement mechanism 430 is arranged to provide relative movement between the aerosol generating component 410 and the consumable 420 along an axis substantially perpendicular to the first direction and the second direction. The direction of the relative movement is shown by arrow C. Movement along the direction indicated by arrow C may move the aerosol generating component 410 and the consumable 420 directly closer or directly further apart. The movement provided by the movement mechanism 430 may be a translation of the aerosol generating component 410 towards the consumable 420, consumable 420 to aerosol generating component 410. The direction indicated by arrow C may be along a “z” axis. In an example, the movement mechanism 430 is arranged to provide relative movement between the aerosol generating component 410 and the consumable 420 along an axis perpendicular to the first direction and the second direction.

Reducing the distance between the aerosol generating component 410 and the consumable 420 may increase the efficiency of aerosol generation. In the example wherein the aerosol generating component 410 is a resistive heater, the heat will transfer more efficiently over the shorter distance between the heater and the consumable 420. As such, a greater amount of aerosol will be provided during one heating process. As such, the power source of the aerosol provision system 400 is more efficiently used thereby improving the lifetime of the aerosol provision system on one full charge of the power source.

In a specific example, the movement mechanism 430 is arranged to provide relative movement between the aerosol generating component 410 and the consumable 420 along an axis perpendicular to the first direction and the second direction (the “z” axis) to provide contact between the aerosol generating component 410 and the consumable 420. This further provides effective heat transfer, in the event the aerosol generating component 410 is a heater.

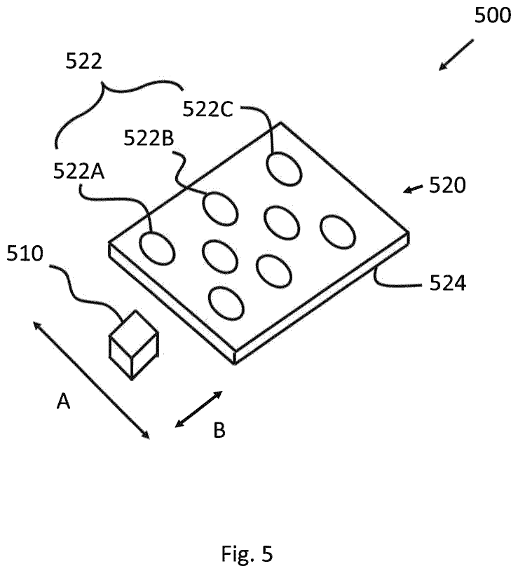

In the example of FIG. 5, a portion of an aerosol provision system 500 is shown. The portion of the aerosol provision system 500 shown has an aerosol generating component 510 and a consumable 520. The consumable 520 has a carrier support 524 and a plurality of portions of aerosol generating material 522. The consumable 520 may comprise a plurality of aerosol generating materials disposed in the first direction and the second direction. The portions 522A, 522B, 522C are shown as individual regions arranged on the carrier support 524. In use, the aerosol generating component 510 may be aligned, via movement along the directions indicated by arrows A and B, with individual portions of aerosol generating material 522. In an example, the aerosol generating material 522 may comprise a plurality of aerosol generating materials such as nicotine, glycerol, acid, etc. In an example, portion 522A is a nicotine-containing aerosol generating material, portion 522B is a glycerol-containing aerosol generating component and portion 522C is an acid-containing aerosol generating material. In an example, the aerosol generating component 510 may be controlled to control the aerosolizable from the individual portions of aerosol generating material 522. In this way, a personalized aerosol may be provided from the aerosol provision system 500.

In an example, the aerosol provision system 500 may have a controller for controlling the relative movement of the aerosol generating component 510 and the consumable 520, for controlling the portions of aerosol generating material 522 that are affected by the aerosol generating component 510. In an example, the aerosol provision system 500 may have a sensor which is able to detect the consumable 520 provided to the aerosol provision system 500. This detection may be signaled to the controller. The controller may have access to a database which enables the controller to recognize the consumable 520 and subsequently be provided with the layout of the aerosol generating material 522 on the carrier support 524. The controller may then control the relative movement of the aerosol generating component 510 and the consumable 520 to provide a desired aerosol to a user. This may be selected by a user from a predetermined plurality of heating profiles or be a bespoke heating profile which is created by the user.

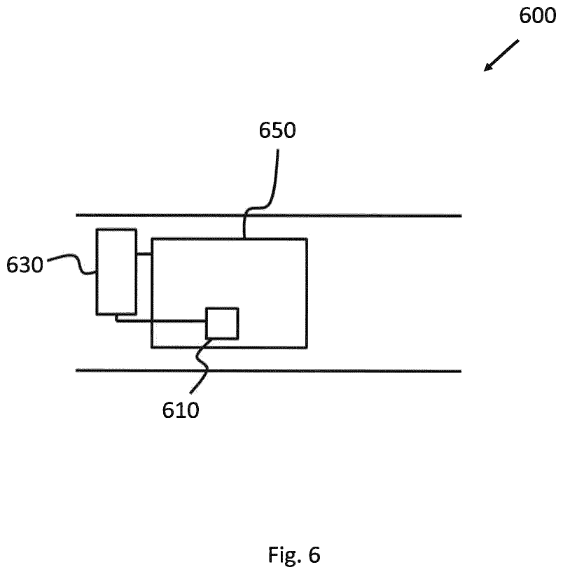

In FIG. 6 an example of a portion of an aerosol provision system 600 is shown. The aerosol provision system 600 has an aerosol generating component 610, a movement mechanism 630 and a receptacle 650. The aerosol provision system 600 comprises a receptacle 650 for receiving at least a part of the consumable. The aerosol generating component 610 may be provided within the receptacle 650 and may be configured to move relative to the receptacle in the first direction and the second direction. The receptacle may be removably insertable into the aerosol provision system 600. The consumable may be preloaded into the receptacle 650, which leads to a cleaner user experience as the user only needs to handle the receptacle 650 which has no aerosol generating material on external surfaces.

In an example, the aerosol provision system of the present disclosure may have a plurality of aerosol generating components. These may be configured to move in the first and/or second directions. The second aerosol generating component may be controlled to move to a different position in the first and second direction compared to the first aerosol generating component. This may allow for a different aerosol portions to be aerosolized simultaneously. This removes a need to rapidly move one aerosol generating component from one portion of aerosol generating material to another on the carrier support to provide an aerosol. As such, wear on the movement mechanism may be reduced over an embodiment with one aerosol generating component.

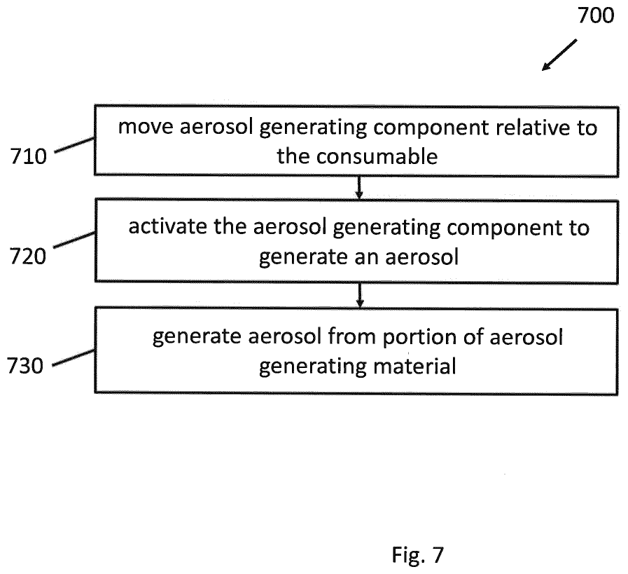

In FIG. 7 an example of a method of generating aerosol from a consumable 700 is shown. The first step 710 involves moving the aerosol generating component relative to the consumable. The second step involves activating the aerosol generating component to generate an aerosol. The third step involves generating aerosol from a portion of aerosol generating material. In an example, the consumable comprises aerosol generating material, the consumable defines a surface at which at least part of the aerosol generating material is disposed, the surface having a characteristic extent in a first direction and a characteristic extent in a second direction.

The movement of the aerosol generating component relative to the consumable in step 710 may involve moving the aerosol generating component relative to the consumable along at least one of an axis substantially parallel to the first direction and an axis substantially parallel to the second direction. In a specific example, the aerosol generating component is moved relative to the consumable along at least one of an axis parallel to the first direction and an axis parallel to the second direction. This movement assists the aerosol generating component to selectively heat certain regions, portions or areas of the aerosol generating material.

In some embodiments, the non-combustible aerosol provision system is an electronic cigarette, also known as a vaping device or electronic nicotine delivery system (END), although it is noted that the presence of nicotine in the aerosolizable material is not a requirement.

In some embodiments, the non-combustible aerosol provision system is a tobacco heating system, also known as a heat-not-burn system.

In some embodiments, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In some embodiments, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision device. However, it is envisaged that articles which themselves comprise a means for powering an aerosol generating component may themselves form the non-combustible aerosol provision system.

In some embodiments, the non-combustible aerosol provision device may comprise a power source and a controller. The power source may, for example, be an electric power source.

In some embodiments, the article for use with the non-combustible aerosol provision device may comprise an aerosolizable material, an aerosol generating component, an aerosol generating area, a mouthpiece, and/or an area for receiving aerosolizable material.

In some embodiments, the aerosol generating component is a heater capable of interacting with the aerosolizable material so as to release one or more volatiles from the aerosolizable material to form an aerosol.

In some embodiments, the substance to be delivered may be an aerosolizable material. Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosolizable material may for example comprise from about 50 wt %, 60 wt % or 70 wt % of amorphous solid, to about 90 wt %, 95 wt % or 100 wt % of amorphous solid.

The aerosolizable material may comprise one or more active constituents, one or more carrier constituents and optionally one or more other functional constituents.

The active constituent may comprise one or more physiologically and/or olfactory active constituents which are included in the aerosolizable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, or any other suitable constituent. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorants, cooling agents, heating agents, or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, coloring agents, preservatives, binders, fillers, stabilizers, and/or antioxidants.

In some embodiments, the article for use with the non-combustible aerosol provision device may comprise aerosolizable material or an area for receiving aerosolizable material. In some embodiments, the article for use with the non-combustible aerosol provision device may comprise a mouthpiece. The area for receiving aerosolizable material may be a storage area for storing aerosolizable material. For example, the storage area may be a reservoir. In some embodiments, the area for receiving aerosolizable material may be separate from, or combined with, an aerosol generating area.

Thus there has been described an aerosol provision system comprising: an aerosol generating component for generating an aerosol from an aerosol generating material; a consumable comprising aerosol generating material, the consumable defining a surface at which at least part of the aerosol generating material is disposed the surface having a characteristic extent in a first direction and a characteristic extent in a second direction; and a movement mechanism for providing relative movement between the aerosol generating component and the consumable, wherein the movement mechanism is arranged to provide relative movement between the aerosol generating component and the consumable along an axis substantially parallel to the first direction and along an axis substantially parallel to the second direction.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the disclosure may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision system comprising:
an aerosol generating component for generating an aerosol from an aerosol generating material;
a consumable comprising aerosol generating material, the consumable defining a surface at which at least part of the aerosol generating material is disposed, the surface having a characteristic extent in a first direction and a characteristic extent in a second direction; and
a movement mechanism for providing relative movement between the aerosol generating component and the consumable,
wherein the movement mechanism is arranged to provide relative movement between the aerosol generating component and the consumable along an axis substantially parallel to the first direction and along an axis substantially parallel to the second direction.

2. The aerosol provision system of claim 1, wherein the movement mechanism is configured to provide relative movement between the aerosol generating component and the consumable such that different regions of the consumable are individually aligned with the aerosol generating component.

3. The aerosol provision system of claim 1, wherein the consumable comprises a carrier support on which the aerosol generating material is arranged,
the carrier support defining the surface having a characteristic extent in the first direction and the second direction.

4. The aerosol provision system of claim 1, wherein the surface defines a plane extending along the first direction and the second direction.

5. The aerosol provision system of claim 1, wherein the first direction is substantially orthogonal to the second direction.

6. The aerosol provision system of claim 1, wherein the movement mechanism is arranged to provide movement to the aerosol generating component.

7. The aerosol provision system of claim 1, wherein the aerosol generating component has a surface which extends in the first and second directions, wherein the area defined by the surface is less than the area defined by the surface of the consumable.

8. The aerosol provision system of claim 1, wherein the aerosol provision system comprises a receptacle for receiving at least a part of the consumable, and wherein the aerosol generating component is provided within the receptacle and is configured to move relative to the receptacle in the first direction and the second direction.

9. The aerosol provision system according to any of claim 1, wherein
the movement mechanism is arranged to further provide relative movement between the aerosol generating component and the consumable along an axis substantially perpendicular to the first direction and the second direction.

10. The aerosol provision system of claim 9, wherein
the movement mechanism is arranged to move the aerosol generating component relative to the consumable to provide contact between the aerosol generating component and the consumable.

11. The aerosol provision system of claim 1, wherein the aerosol generating component is a heating element.

12. The aerosol provision system of claim 1, wherein the consumable comprises a plurality of aerosol generating materials disposed in the first direction and the second direction.

13. The aerosol provision system of claim 1, further comprising a second aerosol generating component configured to move in the first direction and/or second direction, wherein the second aerosol generating component is controlled to move to a different position in the first and second direction compared to the first aerosol generating component.

14. The aerosol provision system of claim 1, wherein at least a part of the aerosol generating material is an amorphous solid.

15. An aerosol provision device for providing an aerosol, the device comprising:
an aerosol generating component for generating an aerosol from an aerosol generating material;
a receptacle for receiving a consumable; and
a movement mechanism for providing relative movement between the aerosol generating component and the receptacle,
wherein the movement mechanism is arranged to provide relative movement between the aerosol generating component and the receptacle along an axis substantially parallel to a first direction and along an axis substantially parallel to a second direction.

16. A method of generating aerosol from a consumable, the method comprising:
providing an aerosol generating component;
providing a consumable comprising aerosol generating material, the consumable defining a surface at which at least part of the aerosol generating material is disposed, the surface having a characteristic extent in a first direction and a characteristic extent in a second direction; and
providing a movement mechanism for providing relative movement between the aerosol generating component and the consumable,
moving the aerosol generating component relative to the consumable along at least one of:
an axis substantially parallel to the first direction; and,
an axis substantially parallel to the second direction
and activating the aerosol generating component to generate an aerosol from the aerosol generating material.

17. The method of claim 16, further comprising:
providing relative movement between the aerosol generating component and the consumable such that different regions of the consumable are individually aligned with the aerosol generating component.

18. The method of claim 16, further comprising:
providing relative movement between the aerosol generating component and the consumable along an axis substantially perpendicular to the first direction and the second direction.

19. The method of claim 18, further comprising:
moving the aerosol generating component relative to the consumable along an axis substantially perpendicular to the first direction and the second direction to provide contact between the aerosol generating component and the consumable.

20. The method of claim 16, further comprising:
moving the aerosol generating component relative to the consumable to a first location and heating a first portion of aerosol generating material,
moving the aerosol generating component relative to the consumable to a second location and heating a second portion of aerosol generating material,
wherein the first portion of aerosol generating material and the second portion of aerosol generating material are different aerosol generating materials.

21. The method of claim 16, wherein the aerosol generating component is a heating element arranged to heat the aerosol generating material to generate an aerosol.

22. The method of claim 16, wherein the consumable comprises a carrier support, the aerosol generating material being arranged on the carrier support and wherein the carrier support defines the surface having a characteristic extent in the first direction and the second direction.

23. The method of claim 16, further comprising:
arranging at least a part of the consumable in a receptacle,
arranging the aerosol generating component in the receptacle,
moving the aerosol generating component relative to the receptacle in the first and second direction.

24. Aerosol provision means comprising:
an aerosol generating component for generating an aerosol from an aerosol generating means; and,
a consumable comprising aerosol generating material, the consumable defining a surface at which at least part of the aerosol generating material is disposed, the surface having a characteristic extent in a first direction and a characteristic extent in a second direction; and
a movement means for providing relative movement between the aerosol generating component and the consumable,
wherein the movement means is arranged to provide relative movement between the aerosol generating component and the consumable along an axis substantially parallel to the first direction and along an axis substantially parallel to the second direction.
